(19) United States
(12) Patent Application Publication
(10) Pub. No.: US 2003/0145090 A1
(43) Pub. Date: Jul. 31, 2003

(54) Method for tracing a computer connected to a data network

(76) Inventor: Bjarne Egon Ostergaard, Randers (DK)

Correspondence Address: James C. Wray, Suite 300, 1493 Chain Bridge Road, McLean, VA, 22101, US

(21) Appl. No.: 10/058,420

(22) Filed: Jan. 30, 2002

(51) Int. Cl. G06F 15/16

(52) U.S. Cl. 709/229

(57) ABSTRACT

A method for enabling the tracing of a computer connected to a data network, for example the Internet. The computer has an IP address when connected to the Internet, wherein said method comprises storing at least one authorized virtual address, comparing said actual virtual address with said at least one authorized virtual address and in case that said actual virtual address is not identical to an authorized virtual address, sending an electronic message to a predetermined virtual address, said electronic message containing said actual virtual address.

### BACKGROUND OF THE INVENTION

The present invention relates to a method to locate a lost or stolen electronic device via the Internet.

Electronic devices as personal computers and mobile telephones are subject for an ever increasing risk of theft. Therefore, a large number of measures have been undertaken in order to secure the electronic devices against theft, for example by hardware means or by password protection.

Also, in order to locate the devices after having lost them or after theft, different methods have been developed. For example, in U.S. Pat. No. 6,128,739 to Hoyt a method is disclosed for finding a computer, where an e-mail from an unauthorized computer is redirected to a law enforcement agency, thereby transmitting the e-mail address of the unauthorized user of the computer.

This method has the severe draw-back that the thief has to transmit an e-mail with his own sender address, before the method is activated. In other words, if the thief does not use an e-mail system, the alarm system is not activated.

In Cotichini et al's U.S. Pat. No. 6,300,863, a method is disclosed, where an agent, for example a software program, is incorporated in a computer to call a security system via the Internet periodically, for example every fourth hour, to transmit its registration number. Upon receipt of the registration number, the security system compares the number with a list of numbers of reported lost or stolen computers. In case that a match is found, the current IP address is requested from the agent for subsequent tracing of the computer location.

This method has a number of draw-backs. Firstly, because the agent tries to establish a call every fourth hour, the thief may be alerted by being asked for the pass-word for the modem to establish this call. Secondly, the typical light indicators on the modem may alert the thief that a call is being established without intention by the thief. Thirdly, if the thief uses the modem for his telephone while the agent is trying to establish his call, the thief may be alerted by the noise in the telephone due the data transfer to the Internet. Additionally, if the agent establishes a communication line to the Internet, e-mails may automatically be moved to and from the computer as an automatic service configured in the computer, which alerts the thief that something non-intended is going on. Furthermore, the method requires a host computer system for control of the computer.

The method as disclosed in the above mentioned U.S. Pat. No. 6,300,863, foresees that the agent is installed in special system files or even in the hardware of the computer in order to prevent the agent to be erased from the hard disc by disc formatting. However, in this case, a problem occurs when using common anti-virus programs that may regard this agent as not being allowable when compared to normal standards. Also, the Firewall used when sending and retrieving messages may stop the agent from acting properly.

It is therefore the purpose of the invention to provide an alternative method for locating a computer, for example a stolen or lost computer.

### SUMMARY OF THE INVENTION

This purpose is achieved by a method for enabling the tracing of a computer connected to a data network, said computer having an actual virtual address when connected to said network, wherein said method comprises storing at least one authorized virtual address, comparing said actual virtual address with said at least one authorized virtual address and in case that said actual virtual address is not identical to an authorized virtual address, sending an electronic message to a predetermined virtual address, said electronic message containing said actual virtual address.

By computer is meant a moveable electronic apparatus with a data processing unit and a memory unit, for example a personal computer, a laptop computer, a palm pilot, a telephone, an Internet connectable device, for example a television or a refrigerator with interactive data display.

By data network is meant any electronic data network for transport of digital data, for example the Internet or a telephone network.

By virtual address is meant an identification of the data address for the electronic apparatus when connected to the data network, for example an IP (Internet Protocol) address in case the data network is the Internet, or a telephone number in case the data network is a telephone network.

By electronic message is meant a message that is transmitted by electronic means, for example an e-mail (electronic mail), an SMS (Short Message Service) message, a voice mail, or an automated voice telephone message.

The method according to the invention is intended to be stored as a computer program in a data memory of the computer. The data memory may be the hard disc of the computer or any other memory device, for example the ROM BIOS or ROM.

In order to illustrate the versatility of the invention, a number of examples are given in the following, which however shall not limit the general character of the invention.

When a computer is connected to the a network system like the Internet, the virtual address of the computer is a uniquely identified by the so-called IP (Internet Protocol) address, which is a number with standardized format. If the connection is via a permanent data link, for example a so called ADSL (Asynchronous Digital Subscriber Line) or ISDN (integrated services digital network) link, the IP address is permanent for the computer connected to this special link.

In this case, a relocation of the computer to another link will result in assignment of a new IP address to the computer, the next time, the computer is connected to the Internet.

The invention foresees that the new IP address is compared to stored IP addresses and in case of disagreement, an electronic message, for example an alarm message, is sent to a predetermined virtual address. The electronic message may for example be an e-mail or a voice message that is sent to an e-mail address or to a number of e-mail addresses. It could however also be an SMS message or a voice message that is sent to a telephone. Even a combination of different kinds of messages and kinds of virtual addresses is possible. The electronic message contains the actual virtual address of the computer, for example the actual IP address.

If a computer has stolen and the thief connects the computer to the Internet via a link, the actual IP address will be different to any of the stored IP addresses and an alarm is initiated. As a result, the actual IP address will be sent to the predetermined virtual address, for example to the e-mail address of the owner. The owner may then let the computer be located by the IP address, which uniquely identifies the location of the computer.

In order not to alert the unauthorized user, for example the thief, the electronic message is sent without indication to the actual user.

To store more than one authorized virtual addresses, for example IP addresses, in the data memory of the computer has the advantage, that the computer can be connected to several data links without inducing an alarm. For example, the owner or user may wish to connect the computer to the Internet link at home in the evening and at work at day-time. In order not to induce an electronic message to be sent to the predetermined virtual address, the usual IP address for the working place and the IP address for the home link may be stored as authorized virtual addresses.

Especially, when the electronic message is sent to a user with several computers, or when the electronic message is sent to an alarm center, for example the police, the specific computer that has been virtually relocated should be identifiable. Therefore in a further embodiment of the invention, the method foresees generating a unique ID identifying said computer and storing said unique ID in a data memory of said computer, wherein said electronic message also comprises said unique ID. In this case, the electronic message not only contains the actual virtual address but also the ID of the computer.

In case that an alarm or control center is used, it is an advantage, if the unique ID is stored in the database of the alarm center for control reasons. The latter is of great use not only in case that a computer has been lost or stolen but also in a general location system, for example in a school or a company. For example, a computer which normally is located in a certain classroom or office may have been moved to a non-authorized virtual address, for example into another classroom or office. In this case, a computer control center of the school or company may receive the electronic message and keep control of the location of the computers in the school or company. In this case, the unique IDs of the computers are stored in a database also at the control center for proper identification reasons.

In order to get an overview of the different computers in a school or a company, an electronic message may be sent from each computer after a predetermined time, for example once a day. In this case, it is helpful, if this message contains also the unique ID for the computer.

It may also be such that the single user prefers to get a control message that the program on his computer actually works. This may be accomplished by the method according to the invention comprising after a predetermined number of start-ups of said computer or after a predetermined time sending an electronic message to a predetermined virtual address, said electronic message containing said actual virtual address. For example, an e-mail may be sent to the owner's e-mail address once a week or once a month. This indicates the proper functioning of the program.

It may also be such that the predetermined electronic address is from a certain control center. In this case, the proper virtual location of the computer in question is automatically checked at this control center when an electronic message is received, for example once a week from this computer. In this case, it may be of further advantage, if the unique ID of the computer comprises identification for selected components, for example a hard disc, of said computer. In case that a component of the selected type for the computer has been purchased by the owner, for example a hard disc, and installed in his computer, the program in the computer may automatically regenerate a new unique ID. This unique ID may be sent to the control center where the complex unique ID is decrypted and analyzed, which reveals the identification, for example one number, for the computer as a whole and also one number for the new, installed component, for example the hard disc. However, this component, now identified, may have been stolen from another computer, eventually without the knowledge of the purchaser. If the component comes from a computer of which the unique ID also has been stored at the control center, an alarm may be created. Thus, if the stolen component and the receiving computer are known by their unique IDs at the control center, the thief may be traced even if only selling components instead of the whole stolen computer.

If the actual virtual address is not identical to any stored authorized virtual addresses, not only an electronic message may be send for safety reasons, but also certain preselected documents stored on said computer may automatically be encrypting according to a further embodiment of the invention. In this case, the owner or authorized user of the computer may assure that important documents are protected from unauthorized reading and misuse.

Once a computer has been refound and delivered back to the authorized user, the question arises how to decrypt the encrypted documents. For this reason, the user may access the computer program set-up menu and type a certain alphanumeric code in order to access the functional options of the program. Among these options is a decryption of the previously encrypted documents. Instead of typing a certain code, the access to the computer program set-up menu may be linked to the reading of a hardware key, for example an CD-ROM to be read in the CD-ROM drive unit of the computer. Requiring a hardware key to access the computer program set-up menu, where the hardware key is not kept together with the computer, prevents even smart hackers from accessing the computer program set-up menu, which ensures that the program with the method according to the invention functions in a highly safe way.

Using a hardware key necessary for accessing the program set-up menu also takes into account the commercial aspects of the invention. A computer program according to the invention may be distributed without permission among different computer users, for example on a CD-ROM or other transportable memory means. However, copying the hardware key, for example a CD-ROM, is much harder, because there are means internally among the data of the CD-ROM to prevent proper copying. For example, the hardware key may be sent to the proper user who has purchased the computer program only after having incorporated the internal computer serial number in the data on the hardware key. This way, the hardware key can only be used for one specific computer, because the computer program according to the invention will check that the internal computer serial number and the number on the hardware key are identical, before access to the computer program set-up menu is given. Therefore, in order to use a computer program performing the method according to the invention properly, the user has to purchase a hardware key, which takes account for the commercial interest in the authorized distributor of the computer program according to the invention.

In the situation, where access to the Internet is achieved through a telephone modem, the computer may receive a new IP address, each time a new connection to the Internet has been established. This induces the sending of an electronic message for each time, the link to the Internet is used. Thus, the user may choose to disregard the sent electronic messages received by his e-mail account in his daily work. Only when the computer has been lost or stolen, he may pay attention to the received e-mails. So even in this case, the purpose of the invention has been achieved, namely enabling the tracing of the computer when being connected to the Internet.

However, in order not to receive an e-mail for each connection to the Internet via a modem and thereby with time fill up the e-mail account of the user, the sending of the electronic message as a result of a new IP address may be inhibited in the following way. According to a further embodiment of the invention, the computer program performing the method according to the invention when said program is run on the computer automatically starts during start-up of the computer and causes for a limited time the indication of an optically insignificant icon on the display of the computer. During this indication of the icon, an alphanumerical code has to be entered through the keyboard of the computer, the code prohibiting the sending of the electronic message until the computer is started next time. The icon is practically only recognizable by the authorized and attentive user, while being substantially invisible for the untrained user. An alternative to the alphanumerical code entered through the keyboard, a specific pointer indication may have to be performed on the user interface, for example by using the electronic computer mouse with a click on the icon.

In case that the computer is connected to the Internet via a router in a local network, the IP address of the router is sent along with the electronic message, such that also in this way, the location of the computer can be traced efficiently.

The method according to the invention may as well be implemented in a telephone. In this case, the at least one authorized virtual address comprises a telephone number. Thus, the telephone number of an installed telephone card, for example a SIM (Subscriber Identity Module) card, may be identical to one internally stored telephone number. In case that a telephone is stolen or lost and the thief/finder installs a new SIM card, the new number will not be identical to the stored numbers and as soon as the telephone is connected to the telephone network, an electronic message with this new telephone number is sent to a predetermined virtual address, for example the telephone number of the owner or the telephone number of an alarm center. The actual telephone number identifies the thief/finder such that the telephone may be traced and refound. The predetermined virtual address may be a telephone number or an e-mail address, and the electronic message may be an e-mail, a voice message or an SMS message that is sent to one or several e-mail addresses or to one or more telephones.

The invention will be explained further with reference to the drawings.

### BRIEF DESCRIPTION OF THE DRAWINGS

FIG. 1 shows a transmission action between the control center and the computer,

FIG. 2 is a flow chart illustrating the receipt of the computer program,

FIG. 3 is an example of a set-up menu,

FIG. 4 is a flow chart illustrating the functioning of the computer program,

FIG. 5 illustrates the deciphering of the complex unique ID of the computer,

FIG. 6 illustrates the display of the computer during start-up of the program.

### DETAILED DESCRIPTION OF THE PREFERRED EMBODIMENTS

The invention is applicable to a variety of different electronic apparatuses, as mentioned initially. Preferably, the method is implemented as a computer program that is stored in a computer, for example a PC or laptop computer, which is connectable to the Internet. A variety of possible connections is disclosed in the aforementioned U.S. Pat. No. 6,300,863.

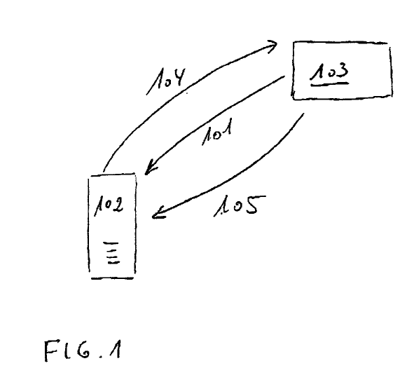

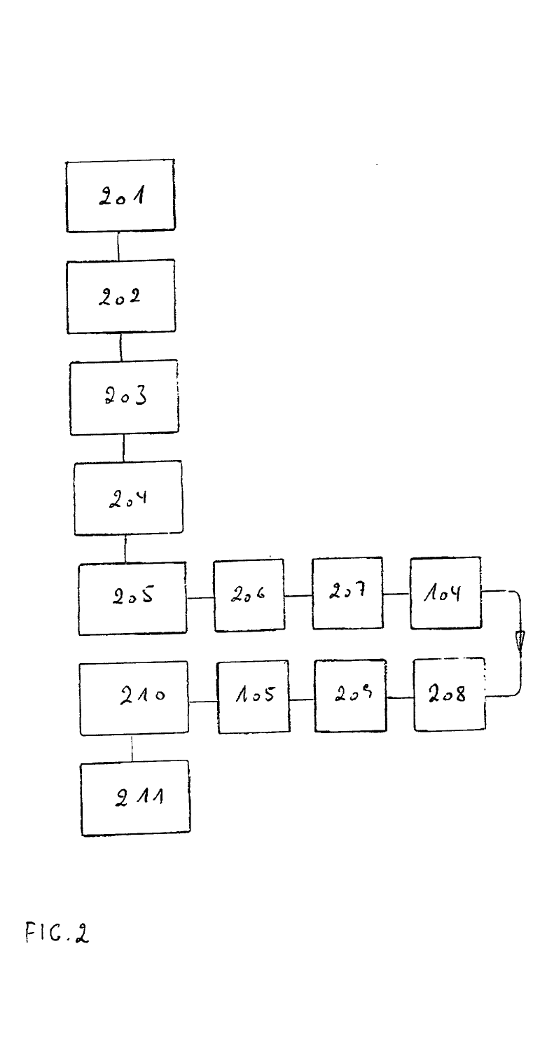

As illustrated in FIG. 1, the computer program may be received 101 by the user of the computer 102 via the Internet from a control center 103. As illustrated in the flow chart of FIG. 2, after having received 201 the computer program, the user is now able to install 202 the computer program, and start it in a first limited version 203. The computer program analyzes the hardware configuration 204 of the computer and determines 205 the serial number of the computer. After having paid 206 for purchase of the program, and if the control center 103 has registered 207 the payment, the user may connect 104 to the control center 103 again, as illustrated in FIG. 1 and FIG. 2. During this connection, the program is caused to send 208 the serial number to the control center 103, where the serial number then is integrated 209 in the data of a hardware key that is sent 105 to the user.

The hardware key having data stored thereon with the serial number is only applicable in connection with the computer 102 that has this particular serial number. Once the hardware key is received 105 and read 210 by the computer 102 in connection with the computer program, a second version of the computer program is started 211. This second version allows the program to run in a hidden mode such that there are no visible indications for the running of the program.

Each time, the computer program set-up menu is to be accessed, the hardware key has to be read 210.

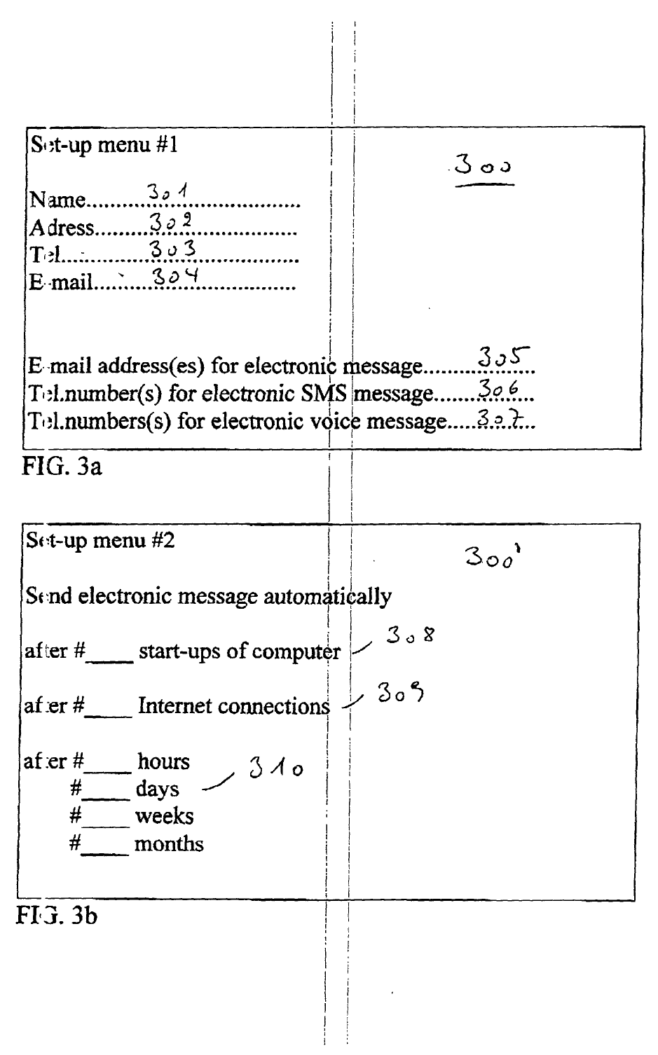

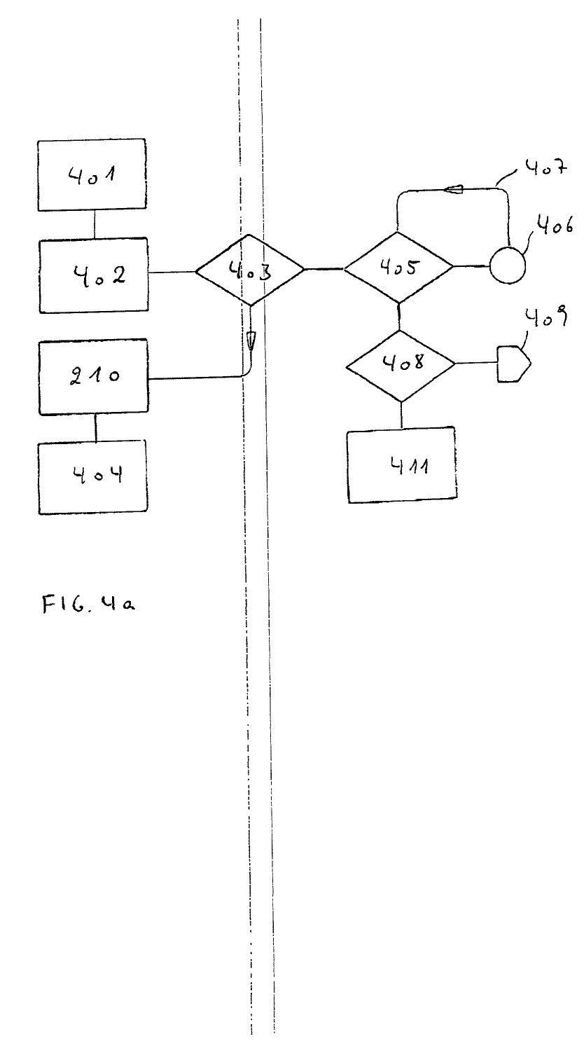

In the computer program set-up menu 300 as shown in FIG. 3a, data can be entered such as name 301, physical address 302, telephone number 303 and e-mail address 304 of the owner or user of the computer. These data may be convenient to store and transmit to the control center 103. Furthermore, the user may indicate the e-mail address or addresses 305 to which an electronic message shall be sent to in case of change of IP address, the telephone number or numbers 306 for SMS messages, and the telephone numbers 307 for sending an electronic voice message. Furthermore, the set-up menu 300′ may also contain the configuration option for sending an electronic message after a predetermined number of computer start-ups 308, or a predetermined number of Internet connections 309, or after a certain time, for example a certain number of hours, days, weeks, or months. The number of start-ups 308, the number of Internet connections 309 and the time 310 may be set by the convenience of the user.

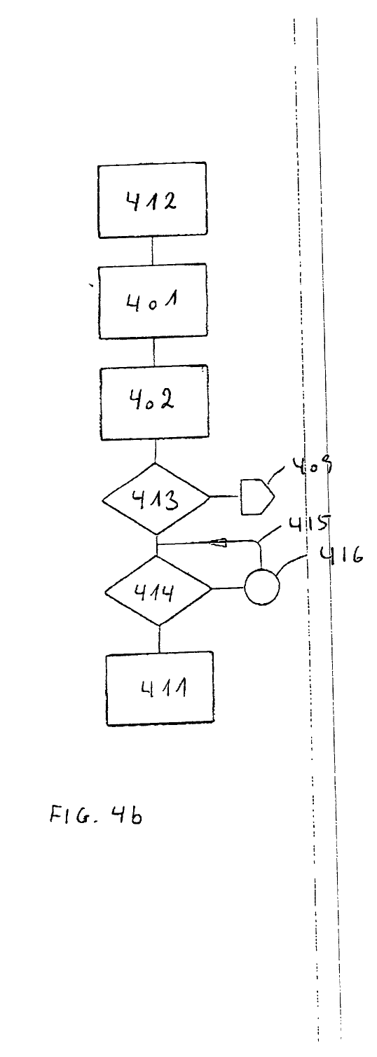

After configuration, the computer program is started 402, as illustrated in FIG. 4a, as a result of the start-up 401 of the computer. A procedure 403 checks whether a hardware key is readable. If the hardware key can be read 210 by the program, the set-up menu 300, 300′ will appear 404 on the display of the computer. If the hardware key is not readable, the computer program goes into a sleeping mode 407. In this sleeping mode, a routine 405 checks whether an actual IP address has been received. If no IP address has been received, a time delay 406 causes waiting for a certain time, for example 10 seconds, before the routine 405 repeats the check for the receipt of an IP address. When an actual IP address is received due to a connection to the Internet, the actual IP address is compared 408 to stored IP addresses and if equal to one of these, the program is terminated 409. In case that the actual IP address is not found among the stores IP addresses, the program uses an established connection to the Internet for sending 411 an electronic message to the predetermined virtual addresses 303, 304, 305.

Alternatively, with reference to FIG. 4b, after start-up 401 of the computer and after start 402 of the program, the computer program may compare 413 whether the latest used IP address, which has been stored 412 during the last Internet connection, can be found among the stored authorized IP addresses. If this is the case, the program is terminated 409. If this is not the case, the program checks 414 whether an on-line connection is established for sending an electronic message. If such a connection to the Internet is not established, the program goes into a loop 415, where it for every time lapse 416, for example 10 seconds, checks whether an on-line connection is established for sending an electronic message. If a connection is established, an electronic message is sent 411. This implies, that an alarm is not given the first time, the computer is connected to the Internet by the unauthorized user and an unauthorized IP address is received and stored. However, the program needs in this case only be active at the start-up of the computer for a very short time during this alternative checking procedure, after which the program may be terminated or may go into a sleeping mode with the loop routine 415 that only requires very little CPU activity. The advantage in this alternative case is that the unauthorized user cannot trace and find the program because the program is only active for a very short time.

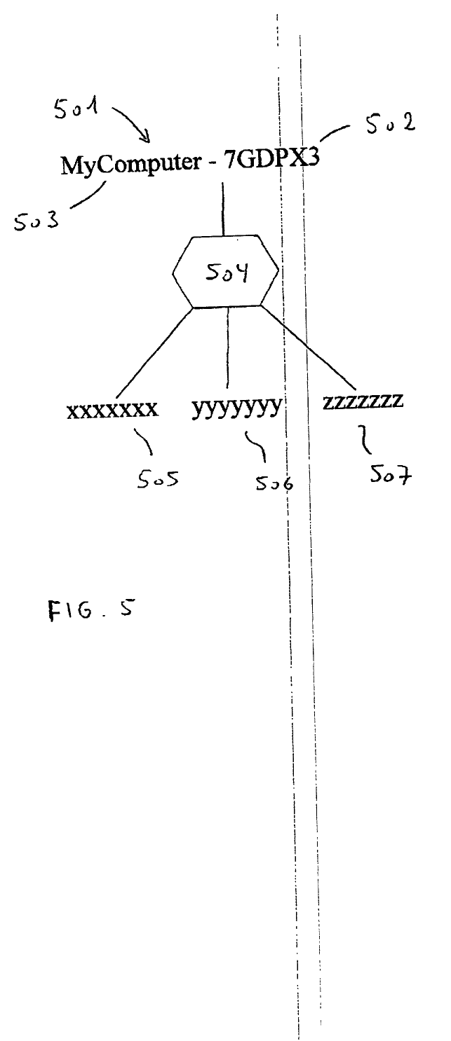

The unique computer ID 501 as shown in FIG. 5 may be a number in alphanumeric format 502 and it may as well contain names 503 for easy identification. The number 502 may be the serial number of the computer itself which the program has read, but the number 502 may as well be an encrypted number constructed by the computer program according to the invention. Alternatively, the number 502 may have been constructed at the control center 103 and sent to the purchaser of the program via the Internet or together with the hardware key. The encrypted number 502 may contain not only data indicative of the true serial number of the computer, but may additionally in an encrypted way contain data indicative of the identifications of selected components that are inside the computer cabinet, for example a data memory or a CD-ROM drive unit. The control center may be able de decipher 504 the encrypted number 502 into the serial numbers 505 of the computer and of the selected components 506, 507. This way, not only a complete computer but also single components may be traced.

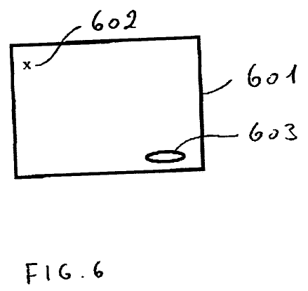

In an additional part of the set-up menu of the computer program, the authorized user with the hardware key may choose an option, where at the start-up procedure a possibility is given to the user to inhibit the functioning of the computer program. This inhibit procedure may be a task to be performed by the user. For example the program may for a limited time indicate on the display of the computer an optically insignificant icon. This situation is illustrated in FIG. 6. The icon 602 on the display 601 may be substantially invisible for the untrained user and practically only recognizable by the authorized and attentive user. During the limited time in which the icon appears, an alphanumerical code has to be entered through the keyboard of said computer. Alternatively, or a specific pointer indication has to be performed, for example a mouse click while pointing at the icon 602.

Instead of an icon 602, a portion 603 of the display may be slightly darker than the rest of the display as an indication to the authorized user, who is aware of the significance of this darker region 603.

The inhibit procedure may be used in a more general sense in that the avoidance of the inhibit procedure always results in sending an electronic message during the following establishment of an Internet connection.

I claim:

1. A method for enabling the tracing of a computer connected to a data network, said computer having an actual virtual address when connected to said network, wherein said method comprises storing at least one authorized virtual address, comparing said actual virtual address with said at least one authorized virtual address and in case that said actual virtual address is not identical to an authorized virtual address, sending an electronic message to a predetermined virtual address, said electronic message containing said actual virtual address.

2. A method according to claim 1, wherein
said data network is the Internet, said virtual address is an IP address, and said electronic message is an e-mail, an SMS message, or a voice message, or
said data network is a telephone network, said virtual address is a telephone number, and said electronic message is an SMS message or a voice message.

3. A method according to claim 1, wherein said electronic message is sent without indication thereof to the actual user of the computer.

4. A method according to claim 1, wherein said method comprises generating a unique ID identifying said computer and storing said unique ID in a data memory of said computer, wherein said electronic message also comprises said unique ID.

5. A method according to claim 1, wherein said method further comprises after a predetermined number of start-ups of said computer or after a predetermined time sending an electronic message to a predetermined virtual address, said electronic message containing said actual virtual address.

6. A method according to claim 5, wherein said unique ID comprises identification for selected components of said computer.

7. A method according to claim 1, wherein said method further comprises in case of said disagreement, encrypting preselected documents stored on said computer.

8. A computer program comprising program code performing the method according to claim 1 when said program is run on a computer.

9. A computer program according to claim 8, wherein said computer program starts automatically during start-up of said computer and causes for a limited time the indication of an optically insignificant icon on the display of said computer, said icon being substantially invisible for the untrained user, during which limited time, an alphanumerical code has to be entered through the keyboard of said computer or a specific pointer indication has to be performed on said user interface, wherein an e-mail is sent to a predetermined address if said alphanumeric code is not entered or said specific pointer indication is not performed, said sending of an e-mail is performed without indication to the user of said computer, said e-mail comprising said actual IP address.

10. A computer program according to claim 8, wherein the computer program set-up menu of said computer program is only accessible after reading a data sequence from a hardware key.

11. A computer program product comprising program code means stored on a computer readable medium for performing the method according to claim 1 when said computer program product is run on a computer.
